(19) United States
(12) Patent Application Publication
(10) Pub. No.: US 2015/0025972 A1
(43) Pub. Date: Jan. 22, 2015

(54) ADVERTISEMENT DELIVERY SYSTEM AND INFORMATION PROCESSING METHOD

(71) Applicant: Hirohisa YABE, Kanagawa (JP)

(72) Inventor: Hirohisa YABE, Kanagawa (JP)

(73) Assignee: RICOH COMPANY, LTD., Tokyo (JP)

(21) Appl. No.: 14/306,531

(22) Filed: Jun. 17, 2014

(30) Foreign Application Priority Data
Jul. 22, 2013 (JP) 2013-151821

(51) Int. Cl. G06Q 30/02

(52) U.S. Cl. CPC G06Q 30/0261
USPC 705/14.58

(57) ABSTRACT

An advertisement delivery system includes a first transmission part configured to transmit to a plurality of devices advertisement information representing an advertisement displayed on the devices; a reception part configured to receive, from the devices which have received the advertisement information, execution information representing that the respective devices have executed a predetermined operation; a first identification part configured to identify two or more of the devices in which the execution information received from the devices meets a first condition; and a second identification part configured to identify more than a predetermined number of the devices from the two or more of the devices identified by the first identification part such that all of the devices identified by the second identification part are located in a circular area with a predetermined radius.

### BACKGROUND OF THE INVENTION

1. Field of the Invention

An aspect of this disclosure is related to an advertisement delivery system and an information processing method.

2. Description of the Related Art

A computer system delivering advertising for devices is known (see Patent Document 1).

In addition, a computer system is known, which delivers, responding to a deliver request from a user while specifying a delivery area, information to an image forming device based on whether the location at which the image forming device is deployed or the location of the user is included in the delivery area.

However, in the conventional computer system, it is difficult to choose an area with higher advertising effectiveness when the user specifies the delivery area for delivering advertising.

### SUMMARY OF THE INVENTION

In one aspect, the present disclosure provides an information processing system, a device management apparatus, an asset management apparatus, and an information processing method, which substantially eliminate one or more problems caused by the limitations and disadvantages of the related art.

In an aspect of this disclosure, there is provided an advertisement delivery system including a first transmission part configured to transmit to a plurality of devices advertisement information representing an advertisement displayed on the devices; a reception part configured to receive, from the devices which have received the advertisement information, execution information representing that the respective devices have executed a predetermined operation; a first identification part configured to identify two or more of the devices in which the execution information received from the devices meets a first condition; and a second identification part configured to identify more than a predetermined number of the devices from the two or more of the devices identified by the first identification part such that all of the devices identified by the second identification part are located in a circular area with a predetermined radius.

According to another embodiment of this invention, there is provided an advertisement delivery method including transmitting to a plurality of devices advertisement information representing an advertisement displayed on the devices; receiving, from the devices which have received the advertisement information, execution information representing that the respective devices have executed a predetermined operation; identifying one or more of the devices in which the execution information received from the devices meets a first condition; and identifying more than a predetermined number of the devices from the two or more of the devices identified with the first condition such that all of the devices identified from the two or more of the devices are located in a circular area with a predetermined radius.

### BRIEF DESCRIPTION OF THE DRAWINGS

Other objects and further features of embodiments may become apparent from the following detailed description when read in conjunction with the accompanying drawings, in which:

FIG. 1 is a diagram showing an overview of an embodiment of the present invention;

FIG. 2 is a diagram showing an advertisement delivery system according to the embodiment;

FIG. 3 is a block diagram showing a hardware configuration of a computer system according to the embodiment;

FIG. 4 is a block diagram showing a hardware configuration of a device according to the embodiment;

FIG. 5 is a block diagram showing a functional configuration of an advertisement delivery management device according to the embodiment;

FIG. 6 is a block diagram showing a functional configuration of a delivery request terminal according to the embodiment;

FIG. 7 is a block diagram showing a functional configuration of an image forming device according to the embodiment;

FIG. 8 is a sequence diagram showing a process according to the embodiment;

FIG. 9A is a table including data according to the embodiment;

FIG. 9B is a table including data according to the embodiment;

FIG. 9C is a table including data according to the embodiment;

FIG. 10 is a flowchart showing a process to store an activation amount of an advertisement according to the embodiment;

FIG. 11 is a flowchart showing a process to specify an expanded area for delivering advertising according to the embodiment; and

FIG. 12 is a sequence diagram showing a process according to the embodiment.

### DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### First Embodiment

### Overview

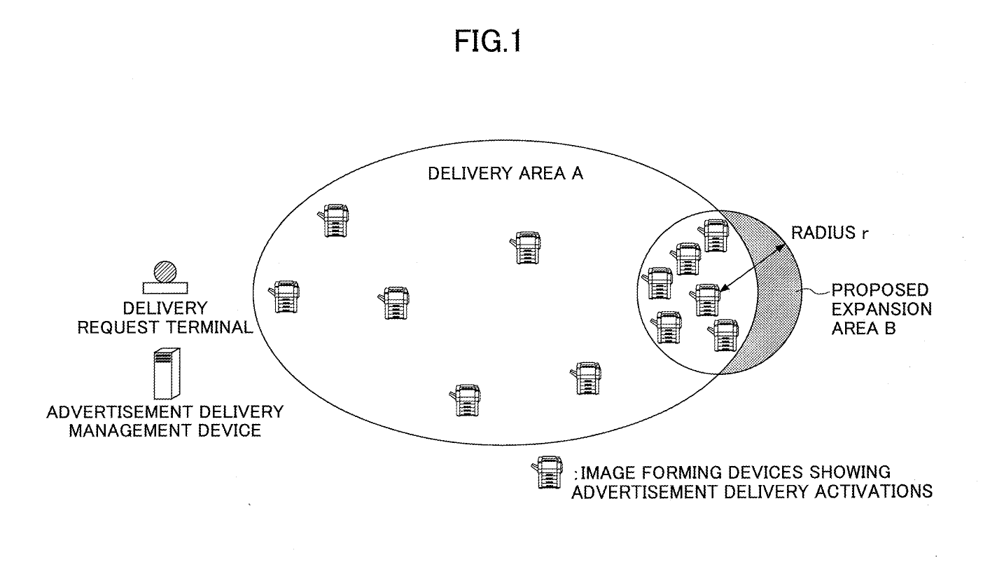

First, with reference to FIG. 1, an overview of this embodiment is discussed. FIG. 1 is a diagram showing an overview of an embodiment of the present invention.

FIG. 1 shows an advertisement system which delivers an advertisement from an advertisement delivery management device to a plurality of image forming devices responding to a request from a delivery request terminal. A person who desires to deliver an advertisement with the advertisement delivery system (a requester for advertisement delivery) sets information about the advertisement (e.g. image data for the advertisement) and areas for delivering the advertisement (e.g. Ebina city, Kanagawa prefecture) to the advertisement delivery management device using the delivery request terminal. While the image forming devices execute a specific function (e.g. boot-up or copying), the image forming devices display the advertisement on the display.

Here, the image forming devices count the number of times for which users of the image forming devices print out the displayed advertisement so that the system may specify the image forming devices for which the counters are greater than or equal to a predetermined number (i.e. specify the image forming devices showing the advertisement delivery effects). When the number of the image forming devices showing the advertisement delivery effects in a certain circle with a radius of r (e.g. 5 km) is greater than or equal to a predetermined number (e.g. 3 units), the system proposes new advertisement delivery to the requester for the image forming devices in the areas within the circle but the advertisement has not been delivered. In other words, the system may propose the requester to deliver the advertisement for the image forming devices located in the area B shown in FIG. 1.

The area close to the area in which the advertisement shows high activations may be expected to also show high advertisement activations. By proposing the requester to deliver the advertisement for the area in which the advertisement has not been delivered but where high advertisement activations are expected, a selection of the areas for additional advertisement delivery may be made easily.

### System Configuration

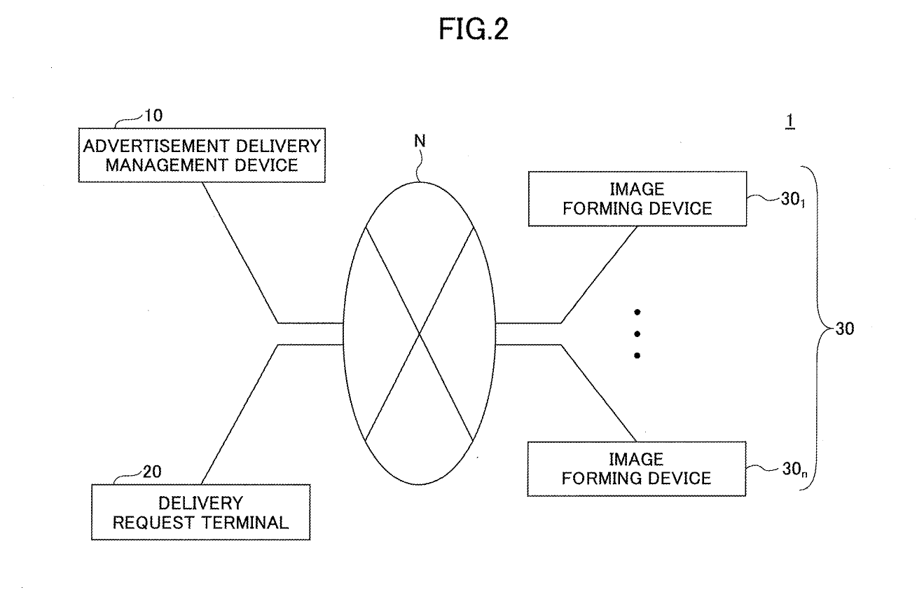

FIG. 2 is a diagram showing an advertisement delivery system according to the embodiment. The advertisement delivery system 1 shown in FIG. 2 may have the advertisement delivery management device 10, the delivery request terminal 20, and the image forming devices 30, which are connected via a network N.

The advertisement delivery management device 10 is an example of a computer. The advertisement delivery management device 10 includes a desktop PC, a laptop PC, etc. The advertisement delivery management device 10 may accept configurations about advertisement delivery from the delivery request terminal 20, and delivers an advertisement for each image forming device 30. Also, the advertisement delivery management device 10 may transmit to the delivery request terminal 20 information to propose an expansion of an area where the advertisement is received.

The delivery request terminal 20 is an example of a computer. The delivery request terminal 20 may include a desktop PC, a laptop PC, etc. The delivery request terminal 20 may perform configurations for the advertisement delivery management device 10 such as settings for advertisement delivery and conditions for an area expansion proposal of advertisement delivery.

The image forming device 30 is an example of a device. The image forming device 30 may be a multifunction peripheral (MFP), a copier, a scanner, a printer, a laser printer, etc. The device may be digital signage, a tablet, etc. in addition to the image forming device. The image forming device 30 may receive the information about an advertisement from the advertisement delivery management device 10, and show the advertisement on the screen.

The network N may be the Internet or a wide area network (WAN). The network N may be wired or wireless. In addition, the network N may include both wired and wireless networks.

Note that the advertisement delivery management device 10 and the delivery request terminal 20 may be deployed on one or more computers.

### Hardware Configuration

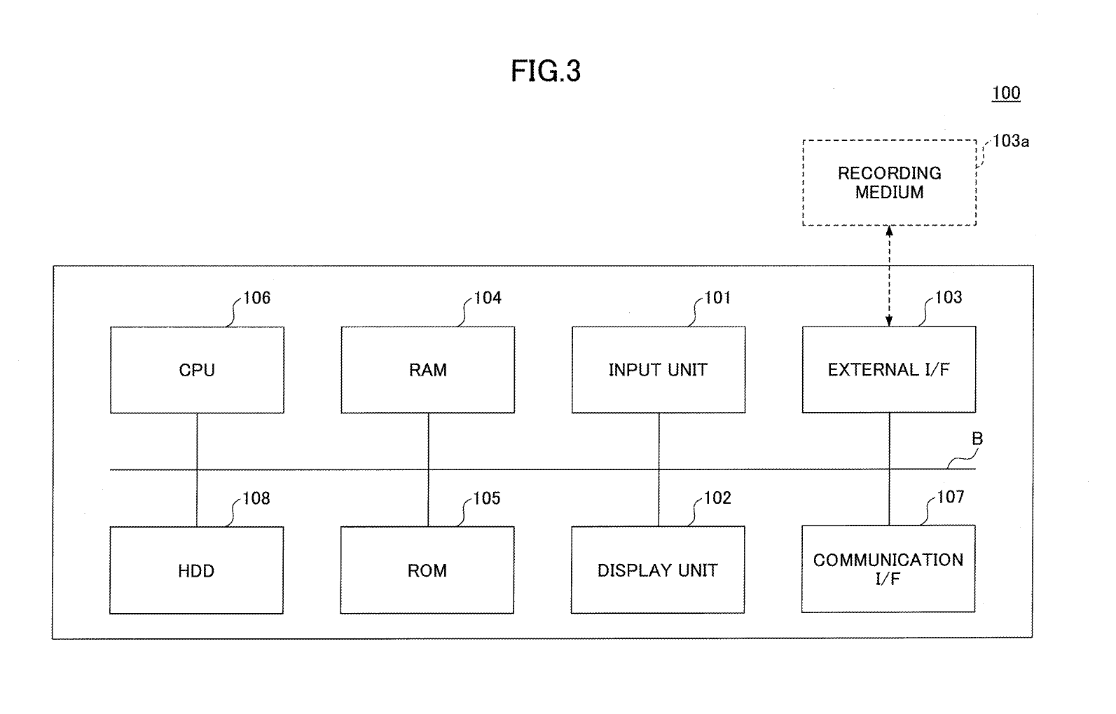

FIG. 3 shows a hardware configuration of a computer system 100. The advertisement delivery management device 10 and the advertisement delivery request terminal 20 may be implemented by the hardware configuration of the computer system 100.

The computer system 100 shown in FIG. 3 may include an input unit 101, a display unit 102, an external interface (I/F) 103, a random access memory (RAM) 104, a read only memory (ROM) 105, a central processing unit (CPU) 106, a communication I/F 107, and a hard disk drive (HDD) 108, which are connected via a bus B, respectively.

The input unit 101 may be a keyboard, a mouse, a touch panel, etc. The input unit 101 is used to input operation signals for the computer system 100.

The display unit 102 may be a liquid crystal display (LCD), a cathode ray tube (CRT), etc. The display unit 102 displays a result output by the computer system 10.

The external I/F 103 is an interface for an external device. An example of the external device is a recording medium 103a. The recording medium 103a may store a program implementing functions according to this embodiment. The computer system 100 may read and/or write data from/to the recording medium 103a via the external I/F 103. Examples of the recording medium 103a are a universal serial bus (USB) memory, a SD memory card, a digital versatile disk (DVD), a compact disk (CD), and a flexible disk.

The RAM 104 is a volatile semiconductor memory (a storage unit) which is able to temporarily store programs and data.

The ROM 105 is a non-volatile semiconductor memory (a storage unit) which is able to maintain stored programs and data. The ROM 105 may store programs and data including a basic input/output system (BIOS) executed on start-up of the computer system 10, an operation system (OS) configuration, a network configuration, etc.

The CPU 106 may load the programs and data from the storage unit such as the ROM 105 and a HDD 108 onto the RAM 104 to execute processing so that the computer system 100 may control and perform the functions according to this embodiment.

The communication I/F 107 is an interface to connect to a network. The communication I/F 107 causes the computer system 100 to execute data communications via the network. The communication I/F 107 may be either an interface for wired communications or wireless communications.

The HDD 108 is a non-volatile storage unit to store programs and data. For example, the stored programs and data include an operating system as basic software controlling the computer system 100, application programs providing various functions on the OS. HDD 108 may manage the programs and data using a file system and/or a database (DB).

The advertisement delivery management device 10 and the delivery request terminal 20 according to this embodiment may implement the functions described below by executing the programs on the computer system 100 having the above-mentioned hardware configuration.

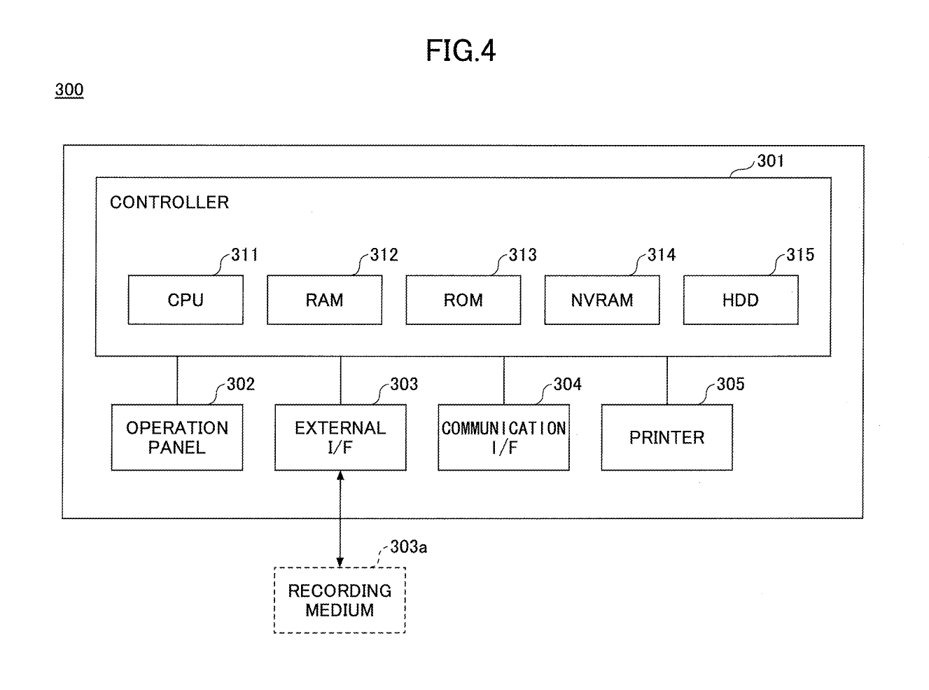

FIG. 4 is a block diagram showing a hardware configuration of a device according to the embodiment. The image forming device 30 may be implemented by the device 300 having the hardware configuration shown in FIG. 4.

The device 300 shown in FIG. 4 may include a controller 301, an operation panel 302, an external I/F 303, a communication I/F 304, and a printer 305.

The controller 301 may have a CPU 311, a RAM 312, a ROM 313, a NVRAM 314, and a HDD 315. The ROM 313 may store various programs and data. The RAM 312 may temporarily store programs and data. The NVRAM 314 may store configuration information, for example. The HDD 315 may store various programs and data.

The CPU 311 may load the programs, data, the configuration information, etc. from the ROM 313, the NVRAM 314, and the HDD 315 onto the RAM 312 to execute processing so that the device 300 may control and perform the functions according to this embodiment.

The operation panel 302 has an input unit to accept an input from a user and a display unit to display data. The external I/F 303 is an interface for an external unit. An example of the external unit is a recording medium 303a. The device 300 may read and/or write data from/to the recording medium 303a via the external I/F 303. Examples of the recording medium 303a are an IC card, a flexible disk, a CD, a DVD, a SD card, and a USB memory.

The communication I/F 304 is an interface to connect the device 300 to the network N. The communication I/F 304 causes the device 300 to execute data communications via the network N. The communication I/F 304 may be either an interface for wired communications or wireless communications.

The printer 305 is a printing device to print data on a paper.

The image forming device 30 according to this embodiment may implement the functions described below by executing the programs on the device 300 having the above-mentioned hardware configuration.

### Software Configuration

### <<Advertisement Delivery Management Device 10>>

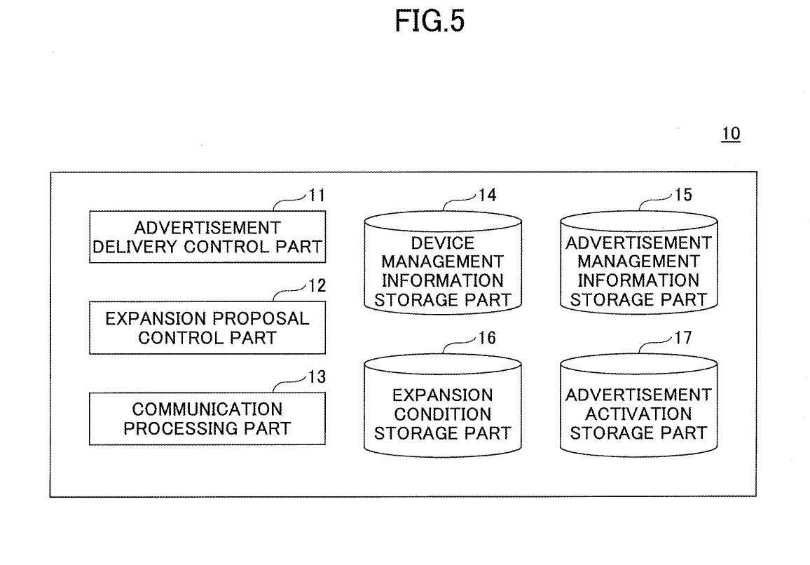

FIG. 5 is a block diagram showing a functional configuration of the advertisement delivery management device 10 according to the embodiment.

The advertisement delivery management device 10 may have an advertisement delivery control part 11, an expansion proposal control part 12, and a communication processing part 13. Each part may be implemented by instructions of one or more programs installed and executed on the advertisement delivery management device 10.

The advertisement delivery management device 10 may have a device management information storage part 14, an advertisement management information storage part 15, an expansion condition storage part 16, and an advertisement activation storage part 17. Each part may be implemented by the HDD 108 or a storage unit connected to the advertisement delivery management device 10 via the network N. The advertisement delivery control part 11 may control advertisement delivery based on the advertisement management information storage part 15. Thus, the advertisement delivery control part 11 may execute a control process to deliver an advertisement for an image forming device(s) 30 in an area(s) specified through the delivery request terminal 20.

The expansion proposal control part 12 may execute a process to specify an area(s) proposed for expansion (proposed expansion area) where the advertisement is newly delivered based on the expansion condition storage part 16 and the advertisement activation storage part 17.

The communication processing part 13 may communicate with the delivery request terminal 20 and the image forming device 30. For example, the communication processing part 13 may perform processes such as advertisement delivery for each image forming device 30 and transmission of information representing the areas specified by the expansion proposal control part 12 to the delivery request terminal 20

The device management information storage part 14 may store information about each image forming device 30. For example, the device management information storage part 14 may store information representing the device IDs of the image forming devices 30 and the installed locations of the image forming devices 30.

The advertisement management information storage part 15 may store information about the advertisement to be delivered. For example, the advertisement management information storage part 15 may store an address of image data for the advertisement to be delivered and the device IDs of the image forming devices 30 which are targeted to deliver the advertisement.

The expansion condition storage part 16 may store conditions to specify the proposed expansion areas.

The advertisement activation storage part 17 may store advertisement activations for the image forming devices 30. The advertisement activation indicates the number of times the delivered advertisement is printed out.

### <<Delivery Request Terminal 20>>

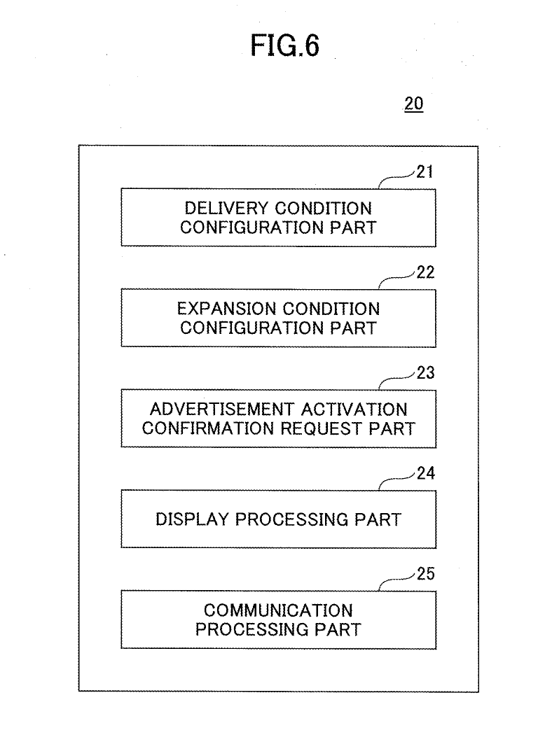

FIG. 6 is a block diagram showing a functional configuration of the delivery request terminal 20 according to the embodiment.

The delivery request terminal 20 may have a delivery condition configuration part 21, an expansion condition configuration part 22, an advertisement activation confirmation request part 23, a display processing part 24, and a communication processing part 25. Each part may be implemented by instructions of one or more programs executed by CPU 106 and installed on the delivery request terminal 20.

The delivery condition configuration part 21 may configure the advertisement management information storage part 15 of the advertisement delivery management device 10. In other words, the delivery condition configuration part 21 may set the image data of an advertisement to be delivered and areas in which the advertisement is delivered.

The expansion condition configuration part 22 may configure the expansion condition storage part 16 of the advertisement delivery management device 10. In other words, the expansion condition configuration part 22 may set a condition to specify the proposed expansion area such as “there are three or more image forming devices 30 in a circle with a radius of 5 km which have advertisement activations which are greater than or equal to 10 times”.

The advertisement activation confirmation request part 23 may transmit to the advertisement delivery management device 10 a confirmation request of the advertisement activation for each image forming device 30 targeted for advertising delivery. Thus, the advertisement activation confirmation request part 23 may request the advertisement delivery management device 10 to acquire information representing the number of times the advertisement is printed out on each image forming device 30.

The display processing part 24 may output information on the display unit 102. For example, the display processing part 24 may display information representing a list of the acquired advertisement activations based on the advertisement activation confirmation request part 23.

The communication processing part 25 may communicate with the advertisement delivery management device 10.

### <<Image Forming Device 30>>

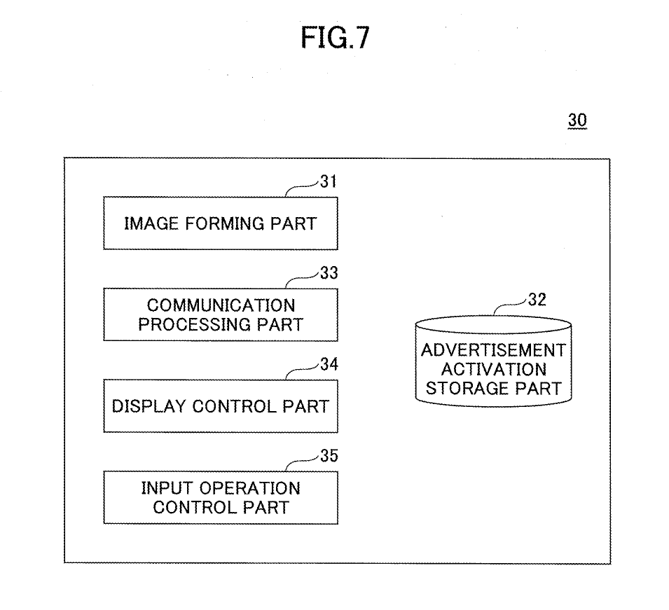

FIG. 7 is a block diagram showing a functional configuration of the image forming device 30 according to the embodiment.

The image forming device 30 may have an image forming part 31, a communication processing part 33, a display control part 34, and an input operation control part 35. Each part may be implemented by instructions of one or more programs executed by CPU 311 and installed on the image forming device 30.

The image forming device 30 may access the advertisement activation storage part 32. The advertisement activation storage part 32 may be implemented by HDD 315 or a storage unit connected to the image forming device 30 via a network.

The image forming part 31 may execute image forming processing, such as copying or printing.

The advertisement activation storage part 32 may store advertisement activations. For example, the advertisement activation storage part 32 may store the number of times that a user of the image forming device 30 prints out the advertisement displayed on the operation panel 302 of the image forming device 30.

The communication processing part 32 may communicate with the advertisement delivery management device 10.

The display control part 34 may output the delivered advertisement on the operation panel 302.

The input operation control part 35 may execute an operation corresponding to an operational signal input by the user of the image forming device 30 on the operation panel 302.

### Process Details

### <<Process Flow>>

In the following, processes performed in the advertisement delivery system 1 according to this embodiment are discussed.

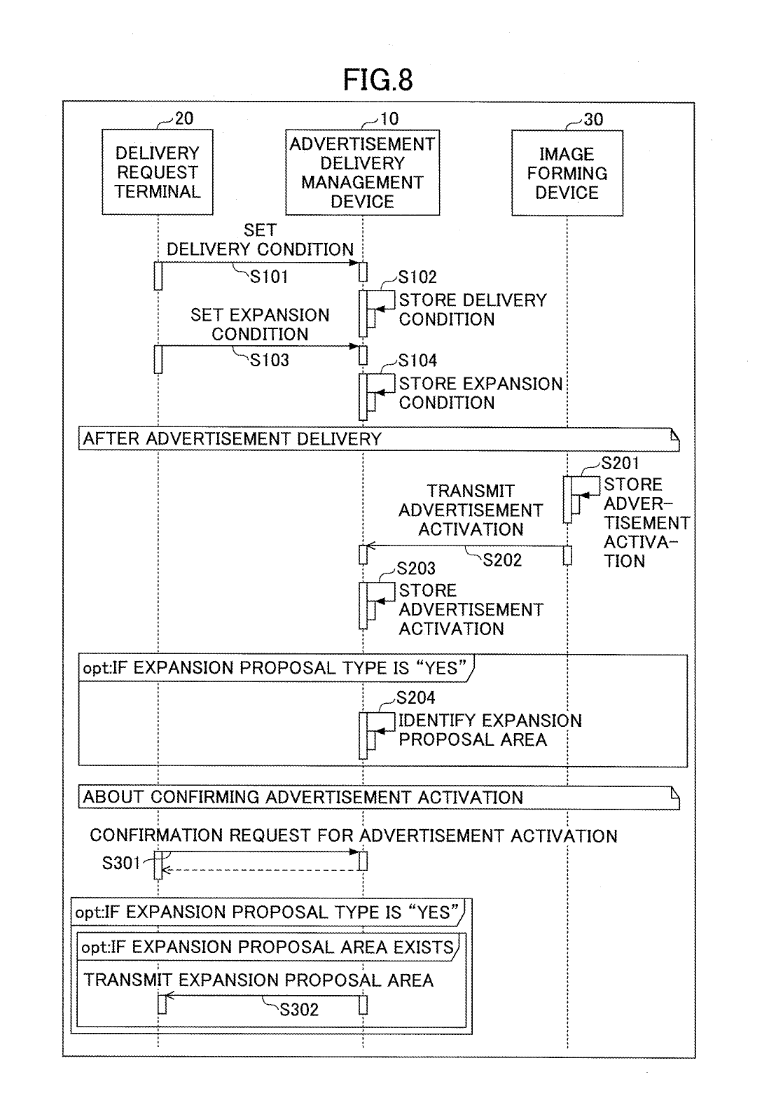

First, a process which enables the advertisement delivery management device 10 to configure conditions for advertising delivery and for specifying the proposed expansion areas responding to input from the requester for advertisement delivery via the delivery request terminal 20. FIG. 8 is a sequence diagram showing the process according to the embodiment.

In S101, the delivery condition configuration part 21 of the delivery request terminal 20 sets conditions of advertisement delivery to the advertisement delivery management device 10. For example, the delivery condition configuration part 21 sets addresses of image data for advertisements to be delivered and areas for the advertisement delivery. Here, the delivery condition configuration part 21 may also set expansion proposal types (YES/NO) used to determine whether to specify the proposed expansion area; or a period for delivering the advertisement.

Note that the delivery condition configuration part 21 may set device IDs of the image forming device 30 targeted for advertisement delivery in addition to set the areas for the advertisement delivery. Also, the delivery condition configuration part 21 may enable the requester to select some of the image forming devices 30 from a list, which are targeted for advertisement delivering.

In S102, the advertisement delivery management device 10 stores the information set by the delivery condition configuration part 21 of the delivery request terminal 20 in the advertisement management information storage part 15. Here, advertisement management information is determined, which is stored in the advertisement management information storage part 15.

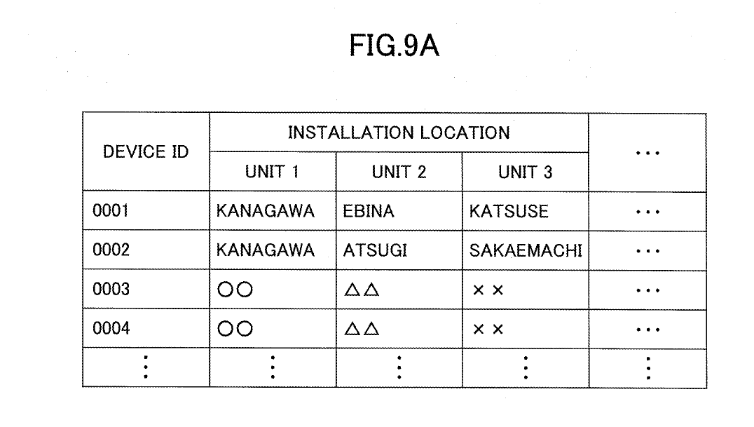

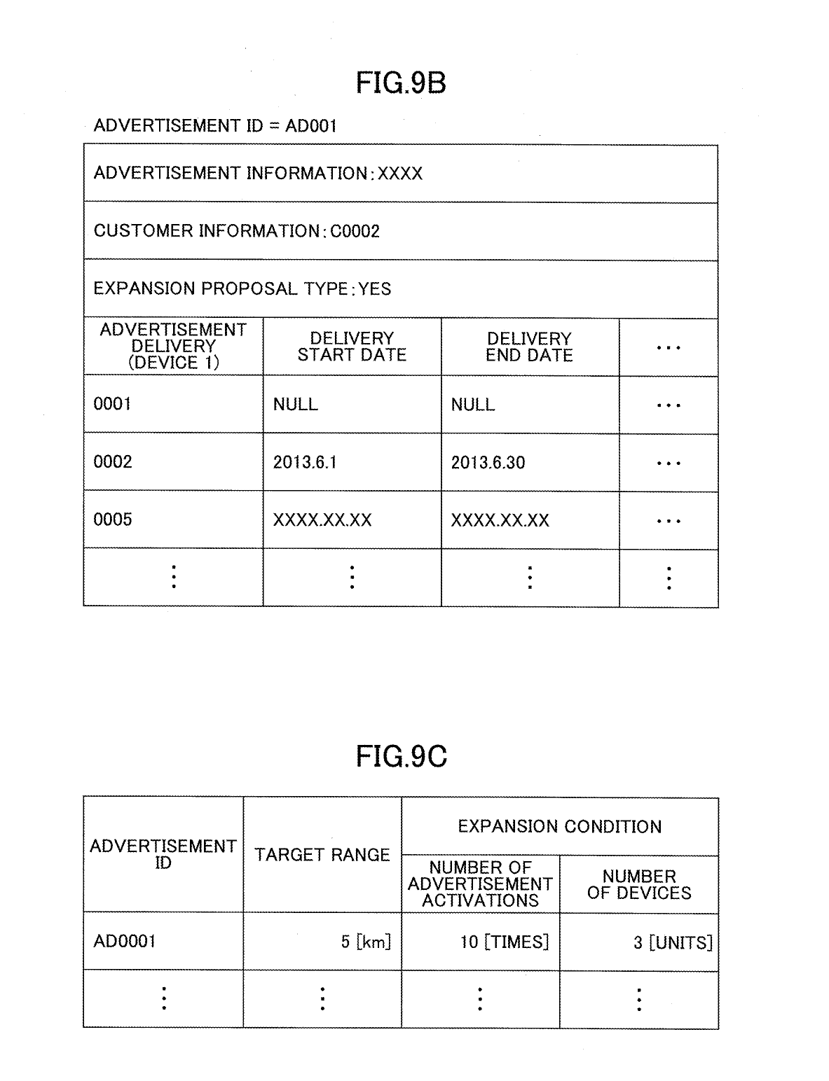

FIG. 9B is a table including the advertisement management information according to the embodiment. The advertisement management information includes an advertisement ID, advertisement information, customer information, an expansion proposal type, an advertisement delivery device ID, a delivery start date, and a delivery end date.

The advertisement ID is an identification to identify advertisement management information. The advertisement ID may be configured by the advertisement delivery management device 10 automatically.

The advertisement information represents an address of image data for an advertisement to be delivered.

The customer information is used to identify a customer (e.g. a customer ID). The customer information may be set by the advertisement delivery management device 10 automatically.

The expansion proposal type indicates whether the proposed expansion area is specified for this advertisement. By invalidating this type (i.e. set “NO” as this type), the proposed expansion area is not specified in the process of specifying an expansion area, which is discussed later.

The delivery start date and the delivery end date defines a period for delivering the advertisement.

The advertisement delivery device ID is a device ID of the image forming device 30 targeted to deliver the advertisement. This device ID may be specified from device management information stored in the device management information stored part 14, for example. Here, the device management information stored in the device management information storage part 14 is discussed.

FIG. 9A is a table including the device management information according to the embodiment. The device management information includes device IDs and deployed locations of all image forming device 30 included in the advertisement delivery system.

The device ID identifies one of the image forming devices 30.

The deployed location indicates a location in which the image forming device 30 is installed. The location is categorized by an administrative region for example. Note that the deployed location may be indicated by positional information obtained from a global positioning system (GPS).

The advertisement delivery device ID in the advertisement management information may be specified as discussed below.

The advertisement delivery management device 10 identifies the device ID of the image forming device deployed in an area, which is input by the delivery condition configuration part 21, from the device management information stored in the device management information storage part 14. When the delivery condition configuration part 21 of the delivery request terminal 20 sets “Ebina (city), Kanagawa (prefecture)” as an area for advertisement delivery, the device management information storage part 14 identifies the device ID of the image forming device 30 the unit 1 of which is “Kanagawa” and the unit 2 of which is “Ebina”. The advertisement delivery management device 10 stores the specified device ID as an advertisement delivery device ID of the advertisement management information.

In S103, the expansion condition configuration part 22 of the delivery request terminal 20 sets a condition to specify an expanded area for advertisement delivering. For example, the condition may be set so as to specify the expansion area when the number of the image forming devices which show 10 or more times advertisement activations in a certain circle with a radius of r (e.g. 5 km) which is greater than or equal to a predetermined number (e.g. 3 units). The condition to extend the area may be set by the requester for advertisement delivery via the delivery request terminal 20. Alternatively, the condition may be set to a predetermined condition by the system.

In S104, the advertisement delivery management device 10 may store expansion condition information set by the expansion condition configuration part 22 of the delivery request terminal 20 in the expansion condition storage part 16. In the following, the expansion condition information stored in the expansion condition storage part 16 is discussed.

FIG. 9C is a table including the expansion condition information according to the embodiment. The expansion condition information includes an advertisement ID, a target range, and an expansion condition. The expansion condition further includes the number of times advertisement activations are submitted (i.e. the advertisement is printed out by a user of the image forming device) and the number of the unit.

The advertisement ID identifies the advertisement management information stored in the advertisement management information storage part 15. The advertisement ID associates the advertisement management information with the expansion condition information.

The target range is a range used to determine whether the image forming device 30 exists, which meets the expansion condition stated later.

The expansion condition may set the number of the advertisement activations and the number of units as a condition to propose an expanded area for advertisement delivery. In other words, the expanded area for additional advertisement delivery may be specified when at least the predetermined number of image forming devices 30 which have at least the predetermined number of advertisement activations exist in the target range. In this embodiment, the expanded area may be specified when the number of the image forming devices which show 10 or more times advertisement delivery success utilizations in a certain circle with a radius of r (e.g. 5 km) which is greater than or equal to a predetermined number (e.g. 3 units).

Next, steps S201 through S204 are discussed, which are executed after delivering the advertisement to each image forming device 30. In an advertisement delivery process, the advertisement delivery control part 11 of the advertisement delivery management device 10 controls advertisement delivery based on the advertisement management information stored in the advertisement management information storage part 15. Thus, the advertisement delivery management device 10 delivers advertisements to the image forming devices 30 specified by the advertisement delivery device IDs in the advertisement management information. The advertisement delivery process is similar to the conventional advertisement delivery process.

In S201, the image forming device 30 stores the advertisement activation in the advertisement activation storage part 32. For example, when a user of an image forming device 30 prints out an advertisement displayed on the operation panel 302, the image forming device 30 increments by 1 the number of activations (e.g. the number of printing) in the advertisement activation storage part 32 as the advertisement activation. An advertisement activation store process is discussed later.

In S202, the image forming device 30 transmits information about an advertisement activation stored in the advertisement activation storage part 32 to the advertisement delivery management device 10. It is preferable that the transmitted information includes at least information about the device ID of the image forming device 30 and the advertisement activation.

The image forming device 30 may transmit to the advertisement delivery management device 10 the advertisement activation at a regular interval or a certain period of time.

In S203, the advertisement delivery management device 10 stores the advertisement activation transmitted from the image forming device 30 in the advertisement activation storage part 17.

In S204, the proposed expansion area is specified. In other word, in S103, the advertisement delivery management device 10 may specify an area to propose expansion of advertisement delivery based on the conditions set by the expansion condition configuration part 22. In this way, the advertisement delivery management device 10 may specify an area in which no advertisement has been delivered yet but high activation of the advertisement is expected, and proposes the area to the requester for advertisement delivery. Details of the process for specifying expansion areas of advertisement delivery are discussed later.

Note that S204 is performed only when the delivery request terminal 20 enables a proposal for extension of delivery areas in S101.

Next, steps S301 and S302 are discussed for confirming the advertisement activation of the advertisement delivered for each image forming device 30 and transmitting the proposed expansion area to the delivery request terminal 10.

In S301, the advertisement activation confirmation request part 23 of the delivery request terminal 20 transmits a confirmation request for the advertisement activation for the advertisement delivery management device 10. The advertisement delivery management device 10 transmits to the delivery request terminal 20 information about the advertisement activation for the device ID of each image forming device 30. In this step, the delivery request terminal 20 may confirm the advertisement activations in the area in which the advertisements are delivered. In other words, the delivery request terminal 20 may confirm the advertisement activation of each image forming device 30 deployed in the area targeted to deliver the advertisement. The advertisement activations are displayed on the display unit 102 of the display request terminal 20 as a list which associates the device ID and the advertisement activation of each image forming device 30 in the area configured to deliver the advertisement. Alternatively, a map, a graph, or a sum of the advertisement activations of all image forming devices 30 in the targeted area may be displayed.

In S302, the advertisement delivery management device 10 transmits to the delivery request terminal 20 information about the proposed expansion area specified in S204.The deliver request terminal 20 displays on the display unit 102 the information about the proposed expansion area transmitted from the advertisement delivery management device 10. Note that the advertisement delivery management device 10 may transmit to the delivery request terminal 20 the region name of the proposed expansion area and/or the device IDs of the image forming devices 30 deployed in the proposed expansion area.

In this way, the requester for advertisement delivery may consider and identify an area for which it is worth delivering the advertisement based on information about the proposed expansion area via the advertisement delivery management device 10.

Note that S302 is performed only when the delivery request terminal 20 enables a proposal for expansion of delivery areas in S101.

The communication processes of the advertisement delivery management device 10, the delivery request terminal 20, and the image forming device 30 in the above-mentioned steps S101 through S302 are executed by the communication processing part 13 of the advertisement delivery management device 10, the communication processing part 25 of the delivery request terminal 20, and the communication processing part 32 of the image forming device 30, respectively.

### <<Advertisement Performance Storing Process>>

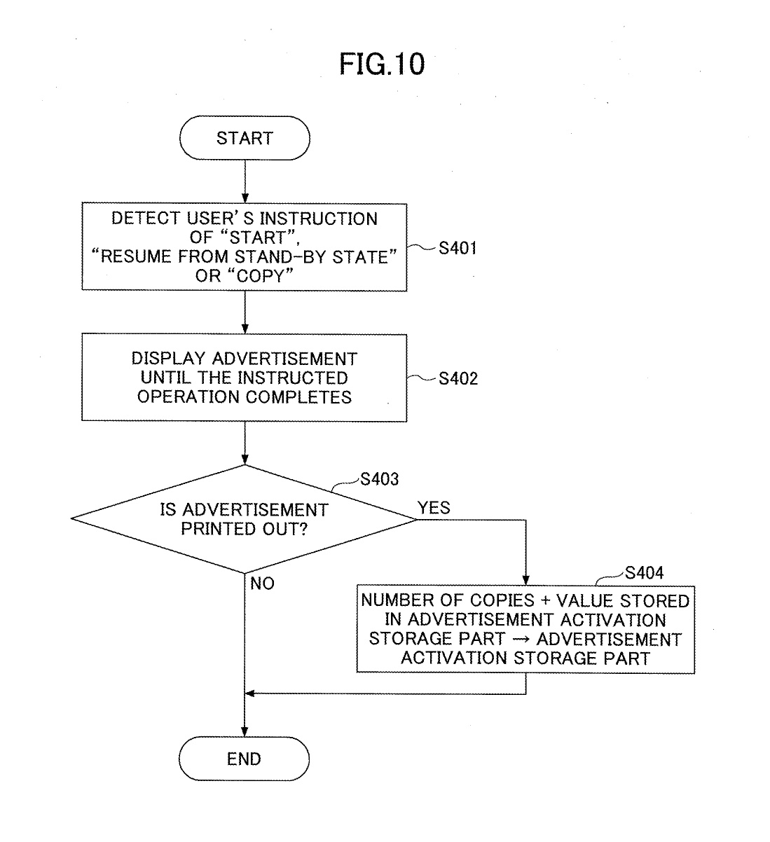

Next, an advertisement activation storing process performed by the image forming device 30 is discussed. FIG. 10 is a flowchart showing a process to store the advertisement activation according to the embodiment.

It is assumed that the advertisement delivery management device 10 transmits to the image forming device 30 information about an advertisement.

In S401, the image forming device 30 detects a user's instruction of “start”, “resume from stand-by state”, or “copy”. “Start” means pushing down the power button of the image forming device 30, for example. “Resume from stand-by state” means resuming from a stand-by state, a sleep state, or a hibernation state. “Copy” means an image forming process such as copying performed by the image forming part 31 of the image forming device 30.

In S402, the image forming device 30 continues to display the advertisement on the operation panel 302 until the operation instructed by the user of the image forming device 30 in S401 completes. For example, the image forming device 30 continues to display the advertisement on the operation panel 302 until the boot-up process completes after the power on and the initial screen is shown on the operation panel 302. For example, the image forming device 30 continues to display the advertisement on the operation panel 302 while an image forming process such as copying is being executed.

The advertisement shown on the operation panel 302 may be printed out when the user pushes (or touches) the area in which the advertisement is shown. In addition, when the user pushes the area, the user may be guided to a webpage on the Internet for the advertisement.

In S403, the image forming device 30 determines whether the advertisement displayed in S402 is printed out. If the image forming device 30 determines that the advertisement displayed in S402 is printed out (YES in S403), the process goes to S404.

In S404, the advertisement activation storage part 32 stores the number of copies (times printed) for the advertisement displayed in S402. In addition, the advertisement activation storage part 32 may store the number of pushes (touches) for the advertisement displayed on the operation panel 302.

As a result, quantitative information about how much users are interested the advertisement displayed on the operation panel 302 of the image forming device 30 may be acquired.

### <<Identification Process of Extension Area for Advertisement Delivery>>

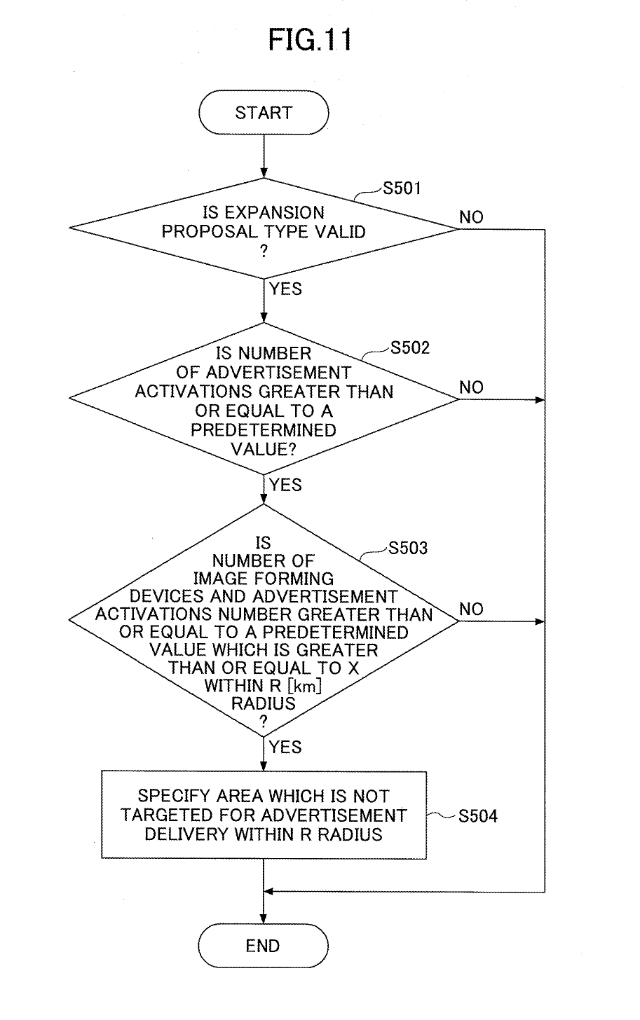

Next, the identification process of the expansion area for advertisement delivery is discussed, which is performed by the advertisement delivery management device 10. FIG. 11 is a flowchart showing a process to specify an expanded area for delivering advertising according to the embodiment. The following steps S501 through S504 are executed for the image forming device 30 deployed in the area targeted to deliver the advertisement. Thus, the steps are executed for each advertisement delivery device ID included in the advertisement management information.

The following example is discussed provided that the identification process is executed for the image forming device 30 having the device ID “0001” when the configured extension information is shown in FIG. 9C.

In S501, the expansion proposal control part 12 of the advertisement delivery management device 10 determines whether the expansion proposal type indicated in the advertisement management information is “YES”. If so (YES in S501), the process goes to S502.

In S502, the expansion proposal control part 12 of the delivery management device 10 determines whether the number of the advertisement activations for the device ID “0001” is greater than or equal to a predetermined number (e.g. 10). In other words, the expansion proposal control part 12 determines the number by acquiring the number of advertisement activations of the device ID “0001” (e.g. the number of copies printed out on the device having the device ID “0001”) from the advertisement activation storage part 17. When the number of advertisement activations of the device ID “0001” is greater than or equal to the predetermined number (YES in S502), the process goes to S503.

In S503, the expansion proposal control part 12 of the advertisement delivery management device 10 determines that, depending on the information representing the installed location of each image forming device 30, the number of the image forming devices 30 and the number of advertisement activations greater than or equal to 10 which is greater than or equal to 3 in a certain circle with a radius of 5 km. When the expansion proposal control part 12 determines that the number of the image forming devices 30 and the number of advertisement activations are greater than or equal to 10 which is greater than or equal to 3 in a certain circle with a radius of 5 km (YES in S503), the process goes to S504.

In the above example, the circle is used to determine that the number of advertisement activations is greater than or equal to the predetermined number. However, any shape such as a rectangle or a polygon may be used.

In S504, the expansion proposal control part 12 of the advertisement delivery management device 10 identifies an area in the circle with a radius of 5 km centering on the device having the device ID “0001”, which is not targeted to deliver the advertisement, as a proposed expansion area. For example, when the installation location of the device having the device ID “0001” is “Ebina (city), Kanagawa (prefecture)”, and the advertisement is not delivered to an image forming device 30 installed in an area of “Atsugi (city), Kanagawa (prefecture)” which is in the circle with a radius of 5 km centering on the device having the device ID “0001”, the expansion proposal control part 12 identifies the “Atsugi (city), Kanagawa (prefecture)” as a proposed expansion area.

The proposed expansion area may be identified by an administrative region at the same level or lower level of the area in which the advertisement has been delivered. Thus, the proposed expansion area may be “Atsugi (city), Kanagawa (prefecture)” or “Sakaemachi (town), Atsugi (city), Kanagawa (prefecture)”.

The expansion proposal control part 12 of the advertisement delivery management device 10 may calculate the proposed expansion area based on the distribution of the image forming devices 30 the number of advertisement activations of which are greater than or equal to the predetermined number within the area specified by the expansion condition information. For example, provided that the proposed expansion areas “Atsugi (city), Kanagawa (prefecture)” and “Zama (city), Kanagawa (prefecture)” are possible, whereas most image forming devices 30 with the number of advertisement activations of which are the predetermined number are located in the west side, “Zama (city), Kanagawa (prefecture)” which is located at the west of “Atsugi (city), Kanagawa (prefecture)” may be identified as a proposed expansion area. In this way, the area in which the advertisement activation is higher may be identified more accurately.

In the above example, area information may be obtained as a proposed expansion area. However, device information about the image forming devices 30 installed the area may be obtained. Thus, the device IDs of the image forming devices in the installation location of which is “Atsugi (city), Kanagawa (prefecture)” may be obtained. In this way, the requester for advertisement delivery may expand the area to deliver the advertisement by a unit of the device ID.

As discussed above, the advertisement activation of an area close to another area in which the advertisement activation is high is also expected to be high. Thus, the advertisement delivery management device 10 may identify the area which is not targeted to deliver the advertisement and the advertisement activation of which is expected to be high. As a result, an additional area for advertisement delivery, the advertisement activation of which is expected to be high, may be proposed for the requester for advertisement delivery.

### Second Embodiment

It is convenient that an advertisement is experimentally delivered to a proposed expansion area identified by the advertisement delivery management device 10. In other words, it is convenient that the advertisement is delivered to the identified proposed expansion area for a predetermined period, and a choice may be made for actual advertisement delivery depending on the advertisement activation for the period.

In the following, the second embodiment is discussed. In the second embodiment, an experimental advertisement delivery is made, and the advertisement activations of the image forming devices 30 receiving the experimental advertisement are obtained.

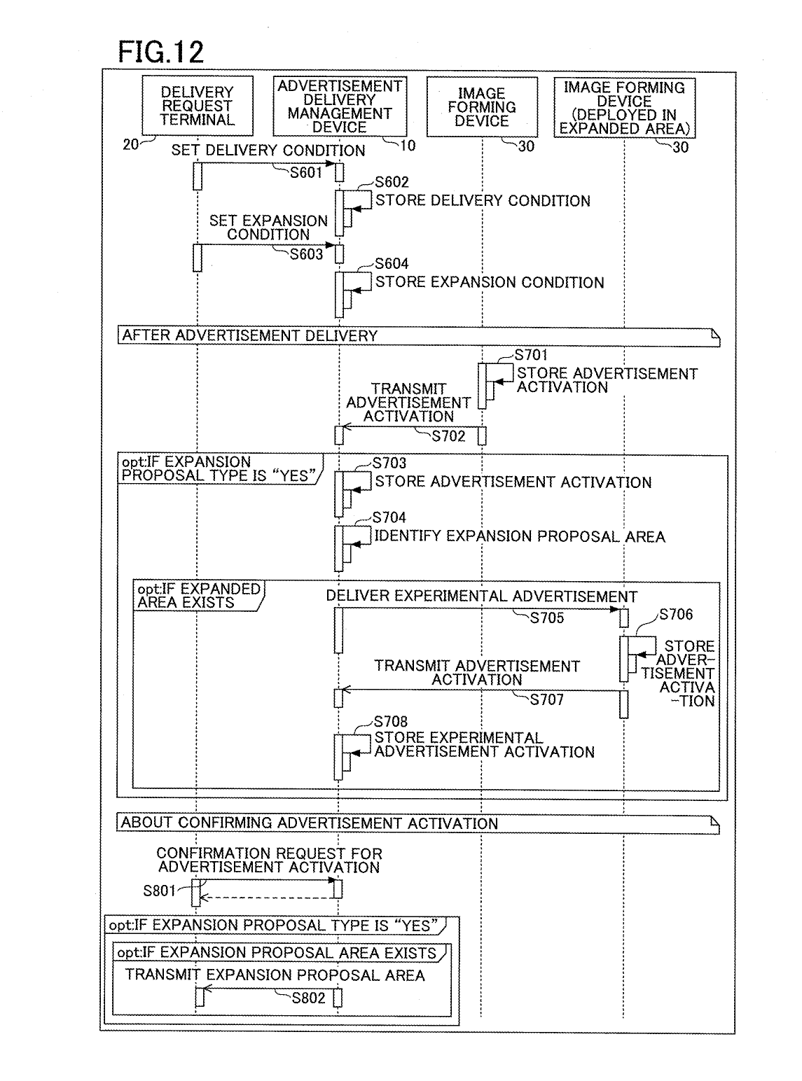

FIG. 12 is a sequence diagram showing a process according to the embodiment.

Steps S601 through S604 are similar to steps S101 through S104. Steps S701 through S704 are similar to steps S201 through S204. Steps S706 through S708 are similar to the S201 through S203. Step S801 is similar to step S301.

In S705, the advertisement delivery control part 11 of the advertisement delivery management device 10 controls advertisement delivery based on the advertisement management information included in the advertisement management information storage part 15. As shown in FIG. 9B, it is preferable that the delivery start date and the delivery end date are set for image forming devices 30 installed in an area for experimental advertisement delivery. In this way, the device having the device ID “0002” may deliver the experimental advertisement in the period from June 2013 to Jun. 30, 2013.

In S802, the advertisement delivery management device 10 transmits to the delivery request terminal 20 information about advertisement activations of the area identified in S704 as well as the area in which the experimental advertisement is delivered. The request for advertisement delivery may consider where to deliver actual advertisements by confirming the advertisement activations in the area in which the experimental advertisement has been delivered.

### CONCLUSION

As stated above, the advertisement delivery system according to this embodiment may identify an area in which the advertisement has not been delivered but high advertisement activations are expected based on conditions for expanding advertisement delivery and advertisement activations for each image forming device 30. In this way, the requester may easily choose an additional area for advertisement delivery.

In addition, the advertisement delivery system according to the other embodiment, the advertisement may be delivered to the identified area experimentally for a predetermined period. In this way, the requester for advertisement delivery may more easily and precisely choose an addition area for advertisement delivery.

In the above-mentioned embodiments, the advertisement delivery management device 10 and the delivery request terminal 20 are examples of advertisement delivery systems. The image forming device 30 is an example of a device. The communication processing part 13 is an example of a first transmission part, a second transmission part, or a reception part. The expansion proposal control part 12 is an example of a first identification part, a second identification part, a third identification part, or a fourth identification part. The expansion condition information is an example of a first condition or a second condition.

Various kinds of embodiments are discussed above, but this invention is not limited to the embodiments. Various modifications and replacement may occur to those skilled in the art without departing from the spirit and scope of the invention.

The present application is based upon and claims the benefit of priority of Japanese Patent Application No. 2013-151821 filed on Jul. 22, 2013, the entire contents of which are incorporated herein by reference.

### PATENT DOCUMENT

### [Patent Document 1] Japanese Laid-open Patent Publication No. 2000-59554

[Patent Document 2] Japanese Patent No. 3851079

What is claimed is:

1. An advertisement delivery system comprising:
a first transmission part configured to transmit to a plurality of devices advertisement information representing an advertisement displayed on the devices;
a reception part configured to receive, from the devices which have received the advertisement information, execution information representing that the respective devices have executed a predetermined operation;
a first identification part configured to identify two or more of the devices in which the execution information received from the devices meets a first condition; and
a second identification part configured to identify more than a predetermined number of the devices from the two or more of the devices identified by the first identification part such that all of the devices identified by the second identification part are located in a circular area with a predetermined radius.

2. The advertisement delivery system as claimed in claim 1, wherein the execution information represents a number of executions of the predetermined operation and the first condition indicates a predetermined number of executions for the predetermined operation.

3. The advertisement delivery system as claimed in claim 1, further comprising a third identification part configured to identify one or more of devices installed in the circular area, which have not received the advertisement information from the first transmission part.

4. The advertisement delivery system as claimed in claim 3, further comprising a second transmission part configured to transmit to the devices identified by the third identification part the advertisement information which causes the devices identified by the third identification part to display the advertisement only for a predetermined period.

5. The advertisement delivery system as claimed in claim 3, further comprising a fourth identification part configured to identify a geographical name of a location in which the devices identified by the third identification part are installed.

6. The advertisement delivery system as claimed in claim 1, wherein the predetermined operation include an image forming operation.

7. An advertisement delivery method comprising:
transmitting to a plurality of devices advertisement information representing an advertisement displayed on the devices;
receiving, from the devices which have received the advertisement information, execution information representing that the respective devices have executed a predetermined operation;
identifying one or more of the devices in which the execution information received from the devices meets a first condition; and
identifying more than a predetermined number of the devices from the two or more of the devices identified with the first condition such that all of the devices identified from the two or more of the devices are located in a circular area with a predetermined radius.
